(19) United States
(12) Patent Application Publication
(10) Pub. No.: US 2007/0202484 A1
(43) Pub. Date: Aug. 30, 2007

(54) Method and System for Educating Individuals

(76) Inventors: Michael Toombs, Kansas City, MO (US); Michele Bridges, Kansas City, KS (US); Richard Fritz, Kansas City, MO (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/680,313

(22) Filed: Feb. 28, 2007

Related U.S. Application Data
(60) Provisional application No. 60/777,712, filed on Feb. 28, 2006.

(51) Int. Cl. G09B 3/00

(52) U.S. Cl. 434/350

(57) ABSTRACT

A method and system of educating individuals including a Student Center that allows individuals to create an on-line persona and adapt the manner of presentation of information to match their interests, background, and aptitudes, a Teacher Center that gives teachers access to data generating during individual tutoring sessions and to professional growth resources, and a Parent Center that gives parents access to the information being presented to the individuals, aids to helping individuals with homework and other resources, a Community Center to educate and inform individuals within the community on the education system, and a Virtual Tutor that works in conjunction with each Center.

### CROSS REFERENCE

The present application is based on Provisional Patent Application Ser. No. 60/777,712, titled “Method and System for Educating Students” which was filed on Feb. 28, 2006. All information included in that application is incorporated by reference.

### FIELD OF INVENTION

The present invention relates generally to a method and system for educating individuals and more particularly to a method and system for educating individuals through an online Virtual Tutor designed to accommodate a variety of individual learning styles and improve communication between all stakeholders relevant in an educational system.

### BACKGROUND OF INVENTION

Education is a term that is used to describe a learning process that includes a wide spectrum from formal education, such as that taught in a traditional classroom, to life experiences, such as those encountered on a daily basis. Education is a lifelong endeavor that is used to teach individuals from the early stages of their life, such as students in elementary school, and continues through everyday experiences an individual faces throughout their life.

In addition to a traditional classroom setting for education, many forms of informal education occur from a variety of sources. Examples include family members, peers, and mass media. These forms of informal education can have a strong influence on an individual.

In traditional classroom settings, teachers are faced with managing classroom order while simultaneously attempting to ensure individuals comprehend pertinent subject matter, absorb information beneficial for long-term foundational concepts, and meet required benchmarks and standards. A rising number of individuals lack primary skills needed to comprehend appropriate grade level course work. Without the essential components needed to digest classroom materials, individuals cannot bridge the gap between the subject matter at hand and their personal lives. With the question of “How does this fit into my life?” individuals lose focus and get stuck in the spin cycle of not understanding the coursework, feeling inept and afraid to admit they do not understand. This feeling of inadequacy can develop into anger towards educators and those in authority and eventually behavioral issues within the classroom. Educators are forced to backtrack to teach basic skills while dealing with increasing numbers of behavioral issues, thereby compromising their ability to lead a class of individuals who meet school standards.

Further, traditional education is focused on the particular learning styles of auditory and visual learning by the teacher either lecturing or the students reading assignments. It is generally known, in the field of education, that at least three main styles of learning exist. These include auditory, visual, and kinesthetic learning. The primary focus of traditional classroom education is auditory learning. Since many individuals do not learn information best through auditory learning, but instead excel through visual or kinesthetic learning, those individuals are at an increased risk of falling behind in the classroom.

Further, auditory learning can be extremely difficult for individuals who do not have a strong command of the English language. If an individual has limited speaking and comprehension of the English language a teaching method that focuses on auditory learning will be of minimal assistance.

Another problem with traditional education in a classroom is that the information presented by the teacher is typically not relevant to all the individuals. Further, since each individual learns at a different pace, it can be difficult to hold the individual's attention, because either the individual is progressing faster than the teacher's learning plan or the individual cannot keep up with the information.

In addition to the problems facing the interaction between the individual and the teacher during the education process, it is also a typical shortcoming of traditional education that parents are not involved enough in the process. To participate in their child's learning process, parents need the ability to access accurate and timely information regarding what is being taught in their child's classrooms. In addition, parents may need “how to” information to further assist them with their child's homework assignments.

Finally, there is a growing need for policy makers and administrators to have access to evaluations of individual success rates and the learning style needs of students in order to make timely changes in policy and funding streams. Adequate funding for policy changes is depended upon to give our nation's teachers and students the resources needed to build a strong educational structure.

In view of the above-described shortcomings related to traditional education systems, there exists a need in the art of teaching for a method or system for educating an individual tailored to the individual's learning style that progresses at a pace that continually holds the attention of the individual. More specifically, there exists a need for a method or system that allows an individual to be immersed in a virtual world where the education method continually is updated based on the questions and answers the individual executes. Further, there exists a need for an education method or system that incorporates real world scenarios into a lesson plan in order to engage the interest of an individual and assist the individual in the development of their creative nature.

Further, there exists a need for a method or system that provides accurate and timely information on an individual's progression through an education system or method for a parent, teacher, policymaker, or administrator. By providing this information further assistance for the individual can be tailored to each circumstance.

### SUMMARY OF THE INVENTION

One aspect of the invention pertains to a method and system for educating individuals. The method and system can be used or implemented for any individual, regardless of a person's background, age, or grade level. The system can be used in a traditional education system for children, such as a classroom or for teaching a group of adults with similar interests. The system utilizes multiple learning styles and languages to personalize the lesson plan dependent on the individuals' different backgrounds, interests, and aptitudes.

Another aspect of the invention is to provide a method and system for educating an individual that allows individuals to change the system interface and adapts to present information in a relevant context based on the individual's learning styles, interests, and cultural background.

Yet another aspect of the invention is to provide a method and system for educating individuals that also provides access for teachers and students to follow individual progress and to access relevant educational resources and professional development opportunities.

In one embodiment of the invention, there is provided a method and system of educating individuals that includes a student center that allows individuals to create an on-line persona and adapt the manner of presentation of information to match their interests, background, and aptitudes, a teacher center that gives teachers access to data generating during individual tutoring sessions and to professional growth resources, a parent center that gives parents access to the information being presented to the students, aids to help students with homework and other resources, and a community center that provides information to policymakers and donors to aide in the development of the education system.

In another embodiment of the invention, the described method and system is implemented in, but not limited to, an internet-based system that is accessible to individuals, teachers, parents, and other stakeholders.

These aspects are merely illustrative of the innumerable aspects associated with the present invention and should not be deemed as limiting in any manner. These and other aspects, features, and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a schematic flow chart of the web-based system, such as, an internet or intranet system for educating individuals according to one embodiment of the present invention.

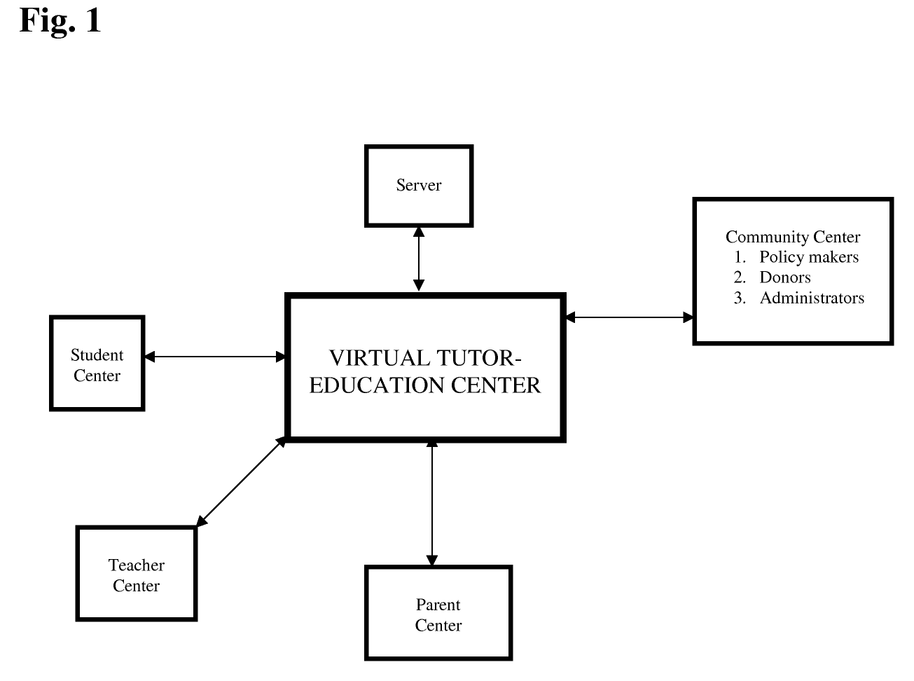

FIG. 2 is a schematic flow chart of the web-based system component designed specifically for the student.

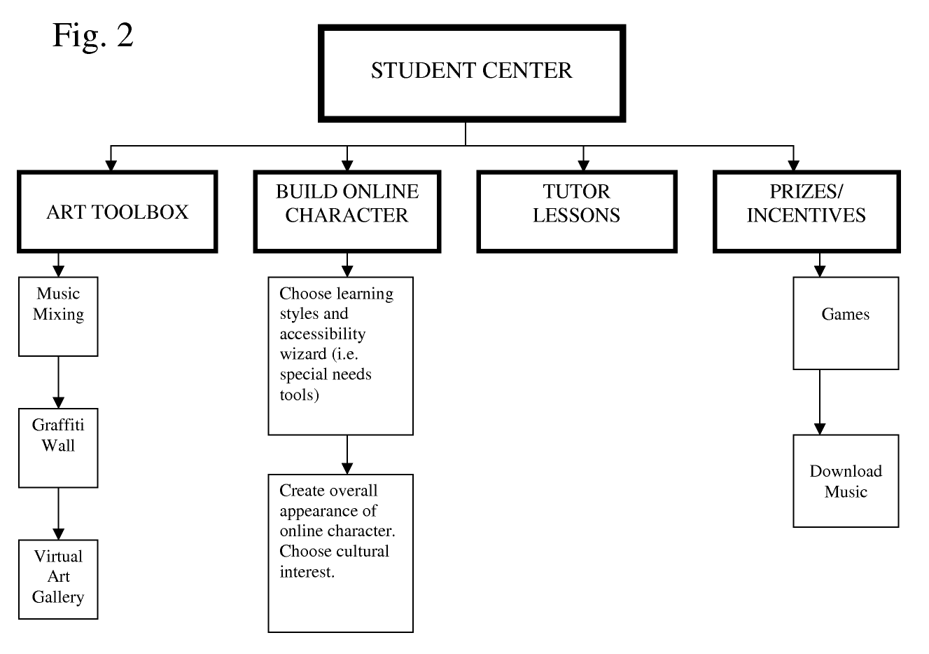

FIG. 3 is a schematic flow chart of the web-based system component designed specifically for the teacher.

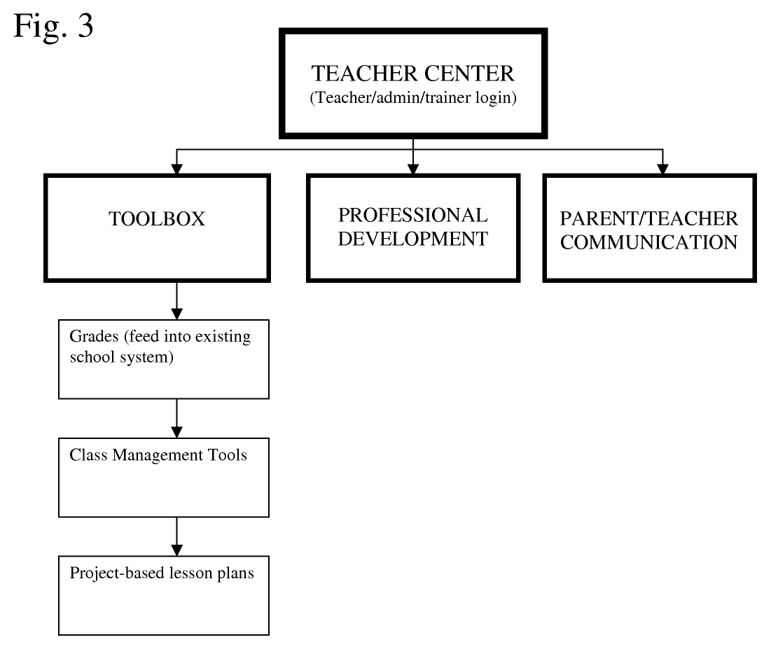

FIG. 4 is a schematic flow chart of the web-based system component designed specifically for the parent.

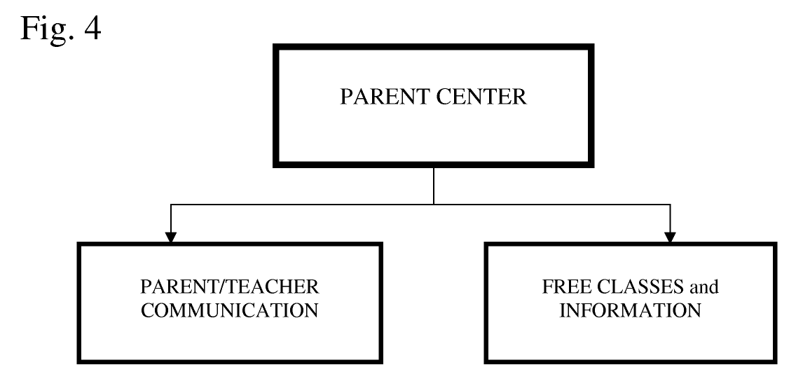

### DESCRIPTION OF THE PREFERRED EMBODIMENTS

The present invention relates to a method and system for educating an individual. More specifically, the invention is directed to an education method and system that incorporates virtual real world scenarios designed to educate students, while at the same time collecting information to assist teachers in educating students, assist parents in the education of their children, and update policymakers and administrators on a student's life including current trends, learning abilities or disabilities, and interests. In the following detailed description, numerous specific details are set forth in order to provide a thorough understanding of the invention. However, it will be understood by those skilled in the art that the present invention may be practiced without these specific details. For example, the invention is not limited in scope to the particular type of industry application depicted in the figures. Nor, is it limited in scope to the individual who can participate in the method. An individual includes a wide spectrum ranging from a preschool or elementary student to an adult interested in a vocation, skill, or particular area of interest. Throughout the application the terms individual and student can be used interchangeably to define an individual that can use the education method or system to learn. In other instances, well-known methods, procedures, and components have not been described in detail so as not to obscure the present invention.

The system provides open communication and collaboration tools that connect students, parents, teachers, and policymakers. For example, parents need timely information about what their child is learning and resources on how to help them. Teachers need to relay quick information to parents about their child's behavior or educational needs outside of school. And policymakers need up to date information on students and the education system in general. The education method and system described herein incorporates this communication and collaboration tool.

The education method described herein delivers information to an individual or student in a process similar to how artists work. The process focuses on experiencing real world scenarios and systematically answering or creating answers that use an individual's knowledge or skills to address the scenario. By engaging the individual in the creative process, the method seeks to address not only academic achievement but also an individual's attitude toward school and their investment in themselves. The method seeks to provide a correlation for the student between academic knowledge and achievement, and real world scenarios that a student will face throughout their life. By incorporating a method or system that mirror or creates real world scenarios the student will be more invested in the experience and understand not only “how” to solve a particular problem but “why” solving a particular problem is beneficial to their life. The system provides a web of support and educational resources to teachers and individuals, as well as distributes vital information to parents, school administrators, and policy makers on a state and national level.

The system includes the components of a Virtual Tutor Education Center designed to interact with a Student Center, Teacher Center, Parent Center, and Community Center. Each Center or module can be used alone, with only the Virtual Tutor, or in conjunction with the other Centers. In addition, the system includes an associated Student Assist program designed to stand alone from the Education Center, but can also be incorporated into the system to aide the student in the development and reinforcement of the skills learned through the Virtual Tutor Education Center.

In one embodiment, the system is a web-based network that includes both internet and intranet capabilities. The web-based system is designed to allow access to an individual from any computer connected to the network allowing individuals, including students, parent, teachers, or other interested parties to log on to and use the system.

In another embodiment, the Virtual Tutor and each of the Centers listed above, including the Student Center, Teacher Center, Parent Center, and Community Center can be a stand-alone software or other common form of computer-readable media. The media will allow the Virtual Tutor to be used on media that are not connected to the internet or an intranet.

In one embodiment, the Virtual Tutor Education Center is a web-based application utilized as a student tutor tool, a learning management tool in the classroom, a teacher assistance program, a data collection tool, a parent assistance program, and a communication and homework tool accessible outside of school. The Virtual Tutor functions to tutor individuals in basic skills and build meaningful relevance to the subject matter in order to develop understanding of the subject and provide guidance to the class. This web-based application is capable of tutoring any subject, comprised of levels ranging from special education to advanced skills and minimal understanding of the English language to bilingual capabilities. Because the system is a web-based application each individual has access to the Virtual Tutor on an infinite number of computers. Further, because the system can be accessed by a single student or an entire classroom the system can serve as a classroom management tool. Teachers are able to continue with the lesson plan while troubled individuals are being tutored by the Virtual Tutor on an individual basis allowing both the class and the individual student to progress at a pace that has been set by each individual.

The Virtual Tutor continually collects statistical data including the students learning styles, most common mistakes made by individuals while learning new material, what information individuals find relevant and how they are able to apply it in life, interest of the students, and what lessons and materials the teachers use. The information collected by the Virtual Tutor can be personal to the student and could therefore be protected or relayed to other users as anonymous data. The information collected is a valuable source for policy makers because it would help them make better budgetary decisions by knowing the training and material needs of the teacher. Also, it is important since charitable donors could find the best place to donate their excess materials, based on the information provided by the teachers.

In one embodiment, the Virtual Tutor communicates with four (4) “Centers”, each Center providing relevant information to individuals/students, parents, teachers, and other community stakeholders, such as policymakers, donors, and administrators. In one embodiment, the four Centers work in conjunction with the Virtual Tutor to enhance the student's education experience. In this embodiment, the Virtual Tutor works as a relay system to collect and distribute information to the student, teacher, parent, and community for a given student or a collection of students. In another embodiment, each Center works alone, in conjunction with the other Centers, or only in conjunction with the Virtual Tutor.

The Student Center or module is a web-based virtual space designed to educate the student through virtual classroom interaction and real life scenarios. The Student Center presents lesson plans in a virtual classroom or in a fashion that correlates academic subjects with real world scenarios. Providing the student with different learning options and types of lesson plans encourages the student in building basic skills that are relevant to the student's future. In addition, the Student Center includes lesson plans that put vocabulary terms into context and apply associated meaning, which again provides useful understanding for the student. In another embodiment, the Student Center works in conjunction with the Virtual Tutor continually seeking questions from the student in order to tailor the lesson plans to the student based on the student's learning style, interests, background, current abilities or disability, as well as relevant real world events. The Student Center and Virtual Tutor are designed to provide lesson plans tailored to each specific individual. In one embodiment, the Student Center and Virtual Tutor continually record data to determine the learning style that will best be understood by the student. The Virtual Tutor will adapt the lesson plan for each student and present the material via auditory, visual, or kinesthetic learning. Where appropriate, the Virtual Tutor uses hands-on training by allowing the student to control the virtual character's hands to perform experiments, pick up objects, and make choices. This hands-on approach will enhance the learning process for many students.

The Student Center is initiated with the student logging on and creating an online character. The virtual character can be created with numerous individual characteristics that the student chooses including, but not limited to, gender, eye color, body type, ethnic background, language of the character, physical appearance, voice, age, name, and combinations thereof. After the student's virtual persona, or character, is created they will move forward to begin personalizing their virtual character, such as by obtaining points to purchase apparel and music selections for their virtual character. In order to obtain points, the student will participate in a series of questions that are designed to assess the student's education level or aptitude, their dominate style of learning, such as auditory, visual, and kinesthetic leaning, and their interests. In addition to the Virtual Tutor assessing the students, the student will also earn points for correct answers, which can then be used to personalize their virtual character.

The assessment step is designed to obtain information that the Virtual Tutor will evaluate in order to tailor the future learning style, lesson plans, and real world scenarios for each individual student. By tailoring the process to each individual student, the student will become invested in the learning experience and begin to develop an understanding of the relationship between academic knowledge and the student's own life experiences. In addition to the student creating a virtual character, the student will also create a virtual character to represent the Virtual Tutor that assists the student. In one embodiment, the Virtual Tutor will act as a virtual character, such as a teacher, that provides lessons and educates the student and the student's online persona. Similar to the traits selected by the student to create their online persona, the student will also select numerous individual characteristics that include, but are not limited to, gender, eye color, body type, ethnic background, language of the character, physical appearance, voice, age, name, and combinations thereof to create their unique Virtual Tutor persona.

In one embodiment, the Student Center and the Virtual Tutor will continually provide reassurance to the student. The reassurance will be in the form of vocal and visual reassurance such as, but not limited to, messages that display and vocally say “good job,” “keep up the good work,” “your answer is incorrect, but that was a good try,” etc. In an additional embodiment, the Virtual Tutor will use language tailored to the student to provide reassurance. The messages will incorporate culturally diverse language and typical urban slang, for example “don't trip, try again”. By continually reassuring the student the Virtual Tutor is instilling a sense of achievement that will help the student continually endeavor to achieve higher levels of education and expand their education horizon. It also reassures the student that trying is important even if they do not know the correct answer.

The Virtual Tutor and Student Center work together to reflect the culture and actions of the real world thus engaging and entertaining individuals while simultaneously educating. Using entertainment and real world scenarios to educate the student, the student will be able to relate to the lesson being taught and this will provide a better means of holding the student's attention. In an exemplary embodiment, if the student is interested in the cultural interest of “pop culture”, the Virtual Tutor will present material as a virtual person to the student dressed in Hip Hop styles or the lesson plan could incorporate a real world scenario where pop culture is intertwined to educate the student. For example, the lesson plan could include hip-hop centered situations and terminology that include a study of the 1992 Los Angeles riots and how this has influenced many Hip Hop music artists that wrote music and lyrics about the turmoil. The Virtual Tutor could then play an online activity with relevant samples of music, directing the individual to analyze and put into context the lyrics that make reference to the L.A. riots. By continually tailoring the lesson plan based on the interests of the student, the Virtual Tutor can focus the lesson plans for a student to continually press the student to achieve higher levels of education.

In another exemplary embodiment, the Virtual Tutor will use real world situations that a student would encounter, for example, related to a job, conversations while hanging out with friends, or shopping and spending money for educating the student. The Virtual Tutor will use these real world situations, for example, to intertwine relationship skills, strategy skills to maximize a purchase for consumer goods, and mathematical skills to understand how much currency is to be paid and ensure that the proper change is received. By incorporating these real world scenarios into the lesson plan the student will begin to understand not only “how” to address a particular problem, but “why” it is important, for example to develop mathematical skills in order to address problems that will arise in the real world.

In another embodiment, the Virtual Tutor transports the virtual character to other historic scenarios that include discussions with virtual famous people, people from a particular period or locale, and tours of both domestic and foreign destinations through virtual or animated field trips. The transportation to view historic places and people provides an opportunity for the Virtual Tutor to reiterate current lesson plans, expand the boundaries of the student, and demonstrate how education, or a particular lesson, shapes individual lives. The Virtual Tutor continues to intertwine lesson plans with the aide of these historic people and places to provide real life context to each particular lesson. By providing these real world scenarios the Virtual Tutor is able to administer lesson plans via numerous learning styles in order to continually challenge and increase the interest of the student related to education.

In addition to providing typical academic education to the student, such as reading, writing, and arithmetic, the Virtual Tutor works in conjunction with the Student Center to develop the creative nature of the student. The creativity aspect of the education is intertwined throughout the process. From the initial creation of the virtual persona or character the student will use their creativity to personalize their virtual character. Creativity is a never ending, always evolving action that aides a student in applying academic education to real world scenarios. The creative development of the student continues as the student's virtual character interacts with the Virtual Tutor. Throughout the interactions between the student's virtual character and the Virtual Tutor the student will continue to gain points. For example, the points are awarded for successful work preformed by the student. This can include correctly answering questions, asking new or novel questions, inquiring about certain historic events, or just providing an inquisitive nature. The points are designed to encourage the student to continually search for knowledge. The collection of points will be viewed by the student as a game and thus help hold their attention while moving through the lesson plans. With the points awarded to the student's virtual character, the student can then redeem the points for prizes. In one embodiment, the virtual character is transported to a mall where the student can redeem the points for: samples of music that can be played during lesson plans such as reading and new assignments administered by the Virtual Tutor; new virtual features for the individual's interactive online character such as apparel, jewelry, hair color and designs, or other personal products; and online games that are designed to enhance the curriculum and lessons learned and/or help individuals develop problem assessment skills, critical thinking skills, social skills, and other creative learning processes.

On a continual basis the Virtual Tutor and/or Student Center records every action the student undertakes via the virtual character. This includes, but is not limited to, questions asked, the student's answers to questions presented by the Virtual Tutor, how the student uses points to personalize their virtual character, what music the student listens to during the lessons, what games the student plays with the points accumulated, and any other interaction the student has with the Virtual Tutor or system in general. By collecting this information the Virtual Tutor is able to continually update the student's preferences, including but not limited to interests, future goals, future career dreams, learning styles, education abilities or disabilities, aptitude, as well as current trends in main stream media, such as likes and dislikes. After this information is recorded the Virtual Tutor compiles a snapshot and detailed overview for each student. By recording this information it becomes easily accessible for the Teacher Center, Parent Center, and Community Center to access and learn about the student. Accessibility of this information will allow those involved in the student's life to provide positive reinforcement and tailor their assistance to those needs that are most pertinent to the student.

The Education method and system can also include a Teacher Center-Professional Development Site. The Teacher Center works alone or in conjunction with the Virtual Tutor to provide valuable information addressing the most common classroom and training needs. Similar to the Student Center, the Teacher Center allows for the same kind of creative input and addresses multiple learning styles. Teacher Center actions could include but are not limited to:
New Teacher Training-Understanding the individual and environment. Individuals create and design videos that portray daily life in their neighborhood. Once uploaded to the Teacher Center these videos allow new teachers to understand the needs, difficulties, and success of his/her students. Other professional development lessons encompass issues most commonly faced in the classroom.
How to teach to multiple learning styles, integrating the arts in the classroom, time management, cultural diversity, slang words of youth, etc.
Provide critical training in how to find and manage volunteers in the classroom.
Finding materials for free and how to write grants to buy equipment.
How and where to apply for fellowships to learn new skills as well as utilizing e-learning sites that offer credit for in-service and re-certification.
Training that addresses brain-based research to understand how individuals learn, enabling the teacher to prepare lessons that better address the needs of the individuals. Detail when certain motor or cognitive skills typically develop in individuals.
Ways to develop lesson plans that connect subjects seamlessly enhancing the individual's comprehension of the subject matter and making it meaningful and relevant to the world in which they live.
   Additional teacher resources:
Collects data and learning styles of individuals as the Student Center and Virtual Tutor are used.
Organizes art projects and net resources by materials used and pictures of finished projects as well as suggestions for possible uses.
Create test worksheets, homework sheets, web-based work and other lesson plans.

In another embodiment, the Education method and system will include a Parent Center. Parents can log onto this version of the Virtual Tutor enabling them to view what their child is learning, and Cliff's Notes for how to help child with homework. In addition any suggestions provided by the parents would be recorded and every attempt to utilize each suggesting would be taken. Parents would thus be more likely to participate if they knew how their suggestions were being considered and utilized. Other Parent Center actions would include but are not limited to:
ESL classes.
Parenting issue classes or support groups.
Resources and how-tos for home buying, getting emergency assistance taxes, resumes, skill set training, or other general life questions.
Providing instructions and materials on post primary and secondary education, such as, but not limited to, community colleges, technical skills training, associate degrees, four year universities, masters programs, and doctorate programs.

In another embodiment, the Education method and system will include a Community Center. The Community Center is a resource guide portion that works with the Virtual Tutor and is dedicated to the individual in the community that influences or assists in the education system. These individuals could include administrators, policymakers, such as school board members or other politicians, as well as charitable donors. The Community Center will include much of the same information found in the Teacher Center, but will further develop the information relevant to community member. Examples will include but are not limited to direct links to community resources within a particular city, region, state, or country, and include how to find and approach volunteers, web boards for dialoging with other educators, parents, and community members. In another embodiment, the Community Center serves as a connection tool to area teachers and schools, for citizens who want to volunteer and businesses that want to donate excess materials or expertise.

In another embodiment, the Community Center will include information on how the resources that have been provided via community funding, government funding, and donor funding are being utilized. In addition, any contributions provided to the students and teachers would be recorded and thus provided an incentive for both those who provided the contribution and those that utilize the products. As well, the logged information would include how individuals, teachers, and parents are benefiting from contributions and collaboration. Donors would be more likely to donate if they were able to find out exactly how their contributions are making a difference.

Each Center is designed with security features that are known in the industry. These security features include, but are not limited to, each Center requiring specific security codes for each individual using or connecting to a Center. The security is important to ensure information collected by the Virtual Tutor, or any of the Centers, remains private and is only accessed or used by authorized individuals. The security ensures all data and collection of data is conducted according to typical education industry standards.

In another embodiment, the education method and system will include a Student Assist program designed to rotate classroom responsibilities/duties for each student involved. In one embodiment the Student Assist is used in conjunction with the above discussed Virtual Tutor and Student Center. In another embodiment, the Student Assist can be used as a stand-alone method for educating the student. The Student Assist is a peer-based learning system that encourages the individual student to learn how to help themselves by helping each other. Not only does it encourage the student to become involved in active learning, but it provides additional room management help for the teacher. The students encounter a hands-on approach to the responsibilities typically associated with the teacher, and develop skills to aide with the added responsibility. The student that is chosen as the Student Assist becomes a helper or technician for the teacher and can assist in many activities including, but not limited to, providing hand-outs and collecting papers from other students in the class; helping with reviewing and answering suggestion or question/comment entries in order to help implement class practices; grade papers and assignments; answer phone and take messages for the teacher; assists in classroom setup as necessary (sets up visuals, project needs); creates posters for study aides in order to reiterate lessons or main points taught in the class; and help classmates with the Virtual Tutor and Student Center actions.

The method and system described herein also incorporates the arts into the tutoring process through a number of tools. Individuals have an opportunity to design their own on-line identity/character and can choose new clothing for the character through the point rewards program. This feature introduces individuals to numerous creative avenues including, but not limited to, fashion design, graphic design, paintings, music, dance, literature, poetry, photography, or any creative action or process. The point rewards program gives individuals the opportunity to select new music to play during their tutoring sessions, thereby facilitating an understanding of music genre and scores. New video programs are created after or during school in order to feed the new teacher training component. Individuals develop web and graphic design skills through the system's lessons enabling them to develop/enhance the school's website, and create WebPages that highlight individual achievement of the students in the arts. Through Student Assist, individuals develop expressive visual aids to reinforce understanding of academic concepts. Language arts foundational skills are reinforced through the use of poetry and storytelling. Additionally, any article created by the individual in the virtual world, such as paintings, music, photography, poetry, stories, and apparel or accessories for the virtual character, can be sold to other individuals through virtual art shows, fashion shows, or other markets. The individual who sells the article is given points by the individual who purchases the article. This interaction facilitates a virtual community market and is used to reinforce lessons provided by the Virtual Tutor. Because the system incorporates multiple learning styles, individuals are exposed to creative means of approaching the same problem.

### EXAMPLE

The following is an example of how an individual would use the Student Center to create a virtual persona or character and participate in a lesson from the Virtual Tutor.

To begin a start-up screen would appear on a computer with the computer connected to the internet, an intranet, or using a software program. The individual in this case is a student that is logging on for the first time.

After the start-up screen has loaded, a preview screen appears that lists the different “Centers” that can be entered. These would include for example, the Student Center, Teacher Center, Parent Center, and Community Center. In this example, the student would select the Student Center. Upon selecting this Center, the student is asked if they are returning or if this is their initial session.

In this example, the student selects the initial session selection. After choosing this selection, the student then proceeds through a list of screens and toolbox selections for creating a virtual persona. The student is asked to create their virtual persona or character that includes such questions related to characteristics of gender, race, skin color, hair color, voice, name, age, as well as general physical features.

After the student has created their virtual persona or character the character is taken to a virtual clothing store to clothe the character. In the virtual clothing store the student's character is allowed to try on any outfit they desire, but the clothing cannot be purchased until points have been collected.

Initially, the virtual character starts with zero points. After the virtual character is created but before clothing is purchased the virtual character enters an assessment section that is designed for 1) the student to collect points and 2) to determine the learning style, interests, and capability of the student. During the assessment section the student will collect points for questions they correctly answer. The assessment section will include numerous questions related to subjects that include questions to test math skills, reading and comprehension, vocabulary, spelling, history, geography, or any other subject. After the student has completed the assessment section they are transported back to the clothing store to purchase apparel for their virtual character.

After the clothing is purchased with the points collected, the virtual character is taken to a mall. The mall is the starting point where the student will proceed with new lesson plans. The mall is designed so that the student can experience how academic knowledge is used in real world situations. In this example the virtual character enters a store and asks to fill out a job application in order to earn points. The job application will list questions that evaluate how the student would interact with customers and handle typical employment responsibilities. During the job application scenario the student would be asked questions they may not be able to answer. If the student answers incorrectly they are transported to the Virtual Tutor.

The Virtual Tutor is a virtual character, voice, or figure that is designed to assist the student in answering the question presented. The Virtual Tutor provides instructions to the student through auditory, visual, and kinesthetic learning styles. This will provide the students with numerous attempts and examples for answering the question. The Virtual Tutor continually provides reassurance to the student and works one-on-one with the student and virtual character to work through the given problem. In this example, if the student becomes frustrated and provides an inappropriate answer the Virtual Tutor will pleasantly reiterate to the student this is not the purpose of the lesson. If the student continues with the inappropriate behavior the Virtual Tutor will use the opportunity to deviate from the lesson plan and transport the student to a time in history where such actions lead to turmoil. The Virtual Tutor will incorporate history lessons, as well as historical facts, to demonstrate the destructive nature of the inappropriate actions. This reiterates that there are consequences related to each action.

Upon learning about how inappropriate behavior can have detrimental consequences the student is transported back to the lesson. After the Virtual Tutor has helped the student answer the question that presented a problem, points are awarded and the student is transported back to the job application.

When the student is finished with the assignment, the Virtual Tutor will prepare a wrap-up and demonstrate for the student how academic knowledge is valuable and will be used in their daily life. Further, it will continually reassure the student.

The preferred embodiment of the invention has been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

We claim:

1. A method for educating a student comprising:
(a) providing a virtual character to represent the student;
(b) providing a virtual tutor that includes a virtual tutor character; and,
(c) enabling the student to direct the actions of the virtual character in a scenario designed to teach a lesson.

2. The method of claim 1, wherein the scenario designed to teach a lesson is a classroom setting or a virtual real life situation.

3. The method of claim 1, wherein the student creates the virtual character using personal characteristics including one or more of the following selected from the group consisting of gender, eye color, body type, ethnic background, language, voice, age, name, and combinations thereof.

4. The method of claim 1, wherein the student creates the virtual tutor character using personal characteristics including one or more of the following, selected from the group consisting of gender, eye color, body type, ethnic background, language, voice, age, name, and combinations thereof.

5. The method of claim 1, wherein the virtual tutor provides lessons to the student using examples incorporating the learning styles of visual, auditory, and kinesthetic.

6. The method of claim 1, wherein the student uses action learning through the virtual character to participate in the education lessons.

7. The method of claim 1, wherein the virtual tutor continually records the student's interaction with the virtual tutor in order to develop a tailored lesson plan for the student.

8. The method of claim 1, wherein the method is a computer implement method.

9. A method for educating a student comprising:
(a) an education center that provides a virtual tutor;
(b) a student center that provides a virtual character to represent the student; and,
(c) a virtual world that enables the student to direct the actions of the virtual character in a scenario designed to teach a lesson.

10. The method of claim 9, wherein the method further includes a teacher center, a parent center, and a community center.

11. The method of claim 9, wherein the student creates the virtual character and a virtual tutor character using the personal characteristics including one or more of the following selected from the group consisting of gender, eye color, body type, ethnic background, language, voice, age, name, and combinations thereof.

12. The method of claim 9, wherein the virtual tutor continually records the students interaction with the virtual tutor in order to develop a tailored lesson plan for the student and provides lessons to the student using examples incorporating the learning styles of visual, auditory, and kinesthetic, dependent on the students dominant learning style.

13. The method of claim 9, wherein the method is a computer implemented method.

14. A system for educating an individual comprising:
(a) an education center;
(b) a student center;
(c) a teacher center;
(d) a parent center; and
(e) a community center.

15. The system of claim 14, wherein the education center provides a virtual tutor.

16. The system of claim 14, wherein the system is a computer implemented system that includes a virtual world designed to educate the individual.

17. The system of claim 14, wherein the student center provides a virtual character to represent the individual.

18. The system of claim 14, wherein the individual directs the virtual character in a scenario designed to teach a lesson.

19. The system of claim 14, wherein the student center, the teacher center, the parent center, the community center, and the education center interact with each other through the education center and the virtual tutor.
